(19) United States
(12) Patent Application Publication
(10) Pub. No.: US 2026/0217115 A1
(43) Pub. Date: Jul. 30, 2026

(54) VEHICLE IMAGE DISPLAY DEVICE

(71) Applicant: TOYOTA JIDOSHA KABUSHIKI KAISHA, Toyota-shi (JP)

(72) Inventor: Shunta UCHIYAMA, Nagoya-shi (JP)

(73) Assignee: TOYOTA JIDOSHA KABUSHIKI KAISHA, Toyota-shi (JP)

(21) Appl. No.: 19/427,279

(22) Filed: Dec. 19, 2025

(30) Foreign Application Priority Data
Jan. 24, 2025 (JP) 2025-010290

(51) Int. Cl. B60K 35/233; B60R 1/28

(52) U.S. Cl. CPC B60K 35/233; B60R 1/28; B60K 2360/119; B60K 2360/18; B60R 2300/8066

(57) ABSTRACT

A vehicle image display device includes an image acquisition unit configured to acquire a rear image captured by a rear camera that captures an image of a rear side of a vehicle; an electronic inner mirror configured to display the rear image acquired by the image acquisition unit and an icon display; a distance detection unit configured to detect a vehicle-to-vehicle distance between another vehicle included in a peripheral image and the vehicle; and a display control unit configured to control a display on the electronic inner mirror such that, when the vehicle-to-vehicle distance detected by the distance detection unit falls below a predetermined threshold value, a degree of overlap between the other vehicle in the rear image and the icon display that are displayed on the electronic inner mirror is reduced.

### CROSS-REFERENCE TO RELATED APPLICATION

This application claims priority to Japanese Patent Application No. 2025-010290 filed on Jan. 24, 2025. The disclosure of the above-identified application, including the specification, drawings, and claims, is incorporated by reference herein in its entirety.

### BACKGROUND

### 1. Technical Field

One aspect of the present disclosure relates to a vehicle image display device.

### 2. Description of Related Art

As a technology related to the vehicle image display device, for example, an image display device disclosed in Japanese Unexamined Patent Application Publication No. 2017-173990 (JP 2017-173990 A) is known. In the image display device disclosed in JP 2017-173990 A, when an input to display menu icons (selection unit) is received from a user while a map image is being displayed on a display unit, the menu icons are displayed, while the map image is blurred, on the display unit overlaid on the map image.

### SUMMARY

As a technology as described above, a vehicle image display device configured to display a peripheral image of a vehicle captured by an imaging unit on a display unit such as an electronic inner mirror is known. In the vehicle image display device, for example, in the following case, the visibility of the user may deteriorate. This is a case where, depending on a mounting position of the imaging unit on the vehicle, in a display on the display unit, a selection unit (such as menu icons) configured to change a display mode of the peripheral image and another vehicle such as a following vehicle included in the peripheral image may overlap with each other.

Therefore, one aspect of the present disclosure provides a vehicle image display device capable of suppressing deterioration of visibility of a user.

The vehicle image display device according to an aspect of the present disclosure is
a vehicle image display device mounted in a vehicle. The vehicle image display device includes:
an image acquisition unit configured to acquire a peripheral image captured by an imaging unit configured to capture an image of a periphery of the vehicle;
a display unit configured to display the peripheral image acquired by the image acquisition unit and a selection unit configured to change a display mode of the peripheral image;
a distance detection unit configured to detect a vehicle-to-vehicle distance between another vehicle included in the peripheral image and the vehicle; and
a display control unit configured to control a display on the display unit such that, when the vehicle-to-vehicle distance detected by the distance detection unit falls below a predetermined threshold value, a degree of overlap between the other vehicle in the peripheral image and the selection unit that are displayed on the display unit is reduced.

In the vehicle image display device according to the aspect,
the selection unit may include a plurality of icon displays, and
the display control unit may be configured to
widen, when the vehicle-to-vehicle distance detected by the distance detection unit falls below the predetermined threshold value and a time-to-collision between the vehicle and the other vehicle is within a predetermined time, an angle of view of the imaging unit, and
change, when the vehicle-to-vehicle distance detected by the distance detection unit falls below the predetermined threshold value and the time-to-collision between the vehicle and the other vehicle is greater than the predetermined time, positions of the icon displays arranged side by side in a left-right row at a lower portion of the display unit to positions of the icon displays arranged side by side in a left-right row at an upper portion of the display unit.

According to the aspect of the present disclosure, it is possible to provide a vehicle image display device capable of suppressing deterioration of visibility of a user.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram showing a configuration of a vehicle image display device according to an embodiment;

FIG. 2 is a schematic diagram for describing detection of a vehicle-to-vehicle distance by a distance detection unit of FIG. 1;

FIG. 3A is a diagram showing a display example of an electronic inner mirror of FIG. 1;

FIG. 3B is a diagram showing a display example of the electronic inner mirror of FIG. 1;

FIG. 3C is a diagram showing a display example of the electronic inner mirror of FIG. 1;

FIG. 4 is a flowchart showing a processing example of the vehicle image display device of FIG. 1;

FIG. 5A is a diagram showing a display example of an electronic inner mirror according to a modification;

FIG. 5B is a diagram showing a display example of the electronic inner mirror according to the modification;

FIG. 5C is a diagram showing a display example of the electronic inner mirror according to the modification;

FIG. 5D is a diagram showing a display example of the electronic inner mirror according to the modification;

FIG. 5E is a diagram showing a display example of the electronic inner mirror according to the modification; and

FIG. 5F is a diagram showing a display example of the electronic inner mirror according to the modification.

### DETAILED DESCRIPTION OF EMBODIMENTS

Hereinafter, the embodiment will be described in detail with reference to the accompanying drawings. The same or corresponding elements in the drawings are designated by the same reference numerals, and redundant description thereof will be omitted.

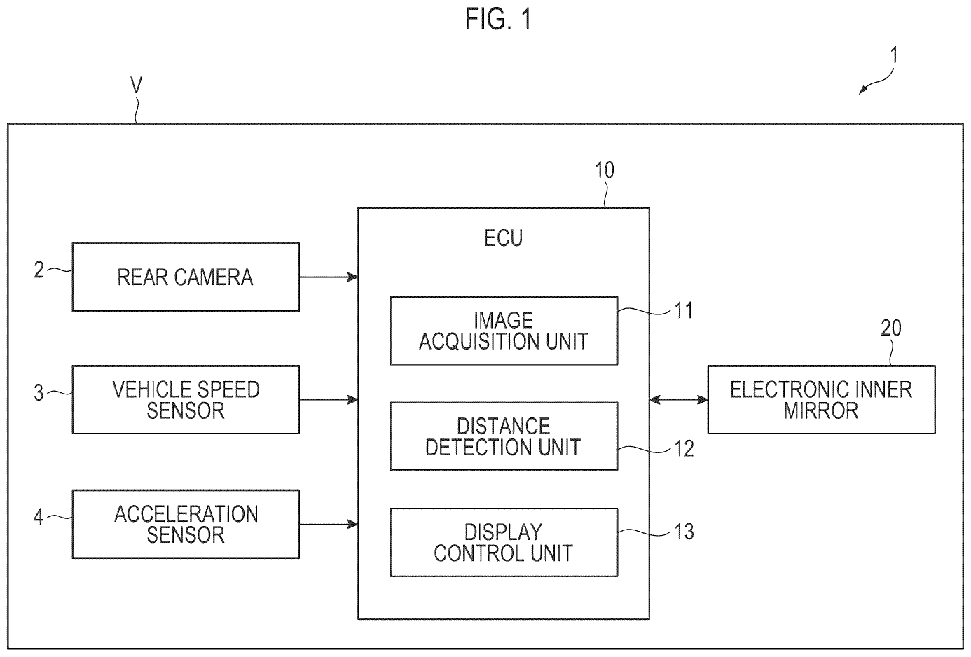

As shown in FIG. 1, a vehicle image display device 1 according to the embodiment is a vehicle image display device mounted on a vehicle V. The vehicle V is not particularly limited, and may be various vehicles. The vehicle image display device 1 includes an ECU 10 and an electronic inner mirror (display unit) 20.

The ECU 10 is an electronic control unit including a processor such as a central processing unit (CPU), a memory such as a read only memory (ROM), and a random access memory (RAM). In the ECU 10, for example, various functions are implemented by loading a program recorded in the ROM into the RAM and executing the program loaded into the RAM by the CPU. The ECU 10 may be configured by a plurality of electronic control units. Some functions of the ECU 10 may be executed by a server that can communicate with the vehicle V. The ECU 10 is connected to a rear camera (imaging unit) 2, a vehicle speed sensor 3, and an acceleration sensor 4.

The rear camera 2 is an imaging device that captures an image of a rear side of the vehicle V. The rear camera 2 may be provided at the rear of the vehicle V. The rear camera 2 transmits a captured image, that is, a rear image (peripheral image) to the ECU 10. The rear camera 2 is not particularly limited, and various cameras can be used. The rear camera 2 has a tilt adjustment function. The tilt adjustment function is a function of adjusting a tilt angle (angle of view in an up-down direction (vertical angle of view)) of the rear camera 2 in an up-down direction. The tilt adjustment function can be implemented, for example, by appropriately moving an orientation of a lens of the rear camera 2 up and down. In the tilt adjustment function, the tilt angle of the rear camera 2 can be adjusted in units of steps. For example, when the number of tilt adjustment steps increases by 1, the tilt angle of the rear camera 2 may increase by about 0.5°. The number of tilt adjustment steps is an integer of 1 or more and n or less (n is an integer of 2 or more). For example, in a case where the number of tilt adjustment steps is n, the tilt angle of the rear camera 2 may be larger than a reference tilt angle by n×0.5° according to the tilt adjustment function.

The vehicle speed sensor 3 is a detector that detects a speed of the vehicle V. The vehicle speed sensor 3 transmits the detected speed of the vehicle V to the ECU 10. The acceleration sensor 4 is a detector that detects an acceleration of the vehicle V. The acceleration sensor 4 includes, for example, a front-rear acceleration sensor that detects an acceleration of the vehicle V in a front-rear direction. The acceleration sensor 4 transmits the detected acceleration of the vehicle V to the ECU 10.

The ECU 10 has, as a functional configuration, an image acquisition unit 11, a distance detection unit 12, and a display control unit 13. The image acquisition unit 11 acquires the rear image captured by the rear camera 2. The distance detection unit 12 detects a vehicle-to-vehicle distance between another vehicle included in the rear image and the vehicle V. The other vehicle is a peripheral vehicle present around the vehicle V. The other vehicle is, for example, a following vehicle. However, the other vehicle is not particularly limited and may be various vehicles.

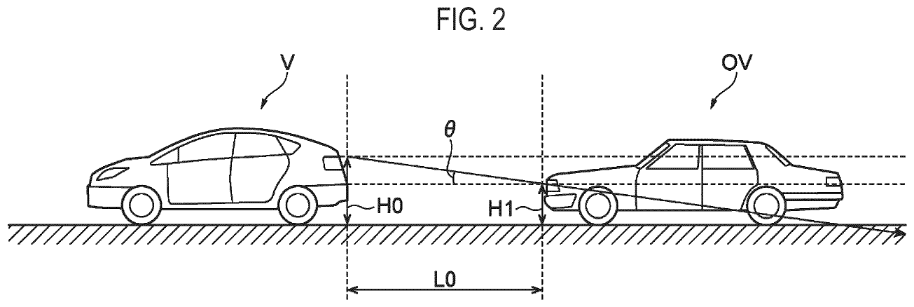

As shown in FIG. 2, the distance detection unit 12 detects a vehicle-to-vehicle distance L0 with another vehicle OV according to Equation (1). H0 is a height at which the rear camera 2 is installed, and may be stored in the ECU 10 in advance. H1 is a height of a location on the other vehicle OV to be seen (hereinafter, also referred to as a “target center”), and the target center is, for example, headlights of the other vehicle OV. As shown in FIG. 2, θ corresponds, in a side view, to an angle between a straight line extending from the rear camera 2 through the target center and a horizontal line.

$$Vehicle - to - vehicle distance L 0 = ( H 0 - H 1 ) / tan θ \qquad ( 1 )$$

In addition, θ can be calculated according to Equation (2). The cutout angle of view of the target center corresponds to an angle of view (field of view) when the target center is cut out from the rear image for use. For example, the cutout angle of view of the headlights of the other vehicle OV indicates what angle of view the portion obtained by cutting out the headlights of the other vehicle OV from the rear image has. The display control unit 13 controls the display on the electronic inner mirror 20.

$$θ = cutout angle of view of target center - number of tilt adjustment steps , described later \times angle of view charge per one tilt adjustment step ( for example , about 0.5 ° ) \qquad ( 2 )$$

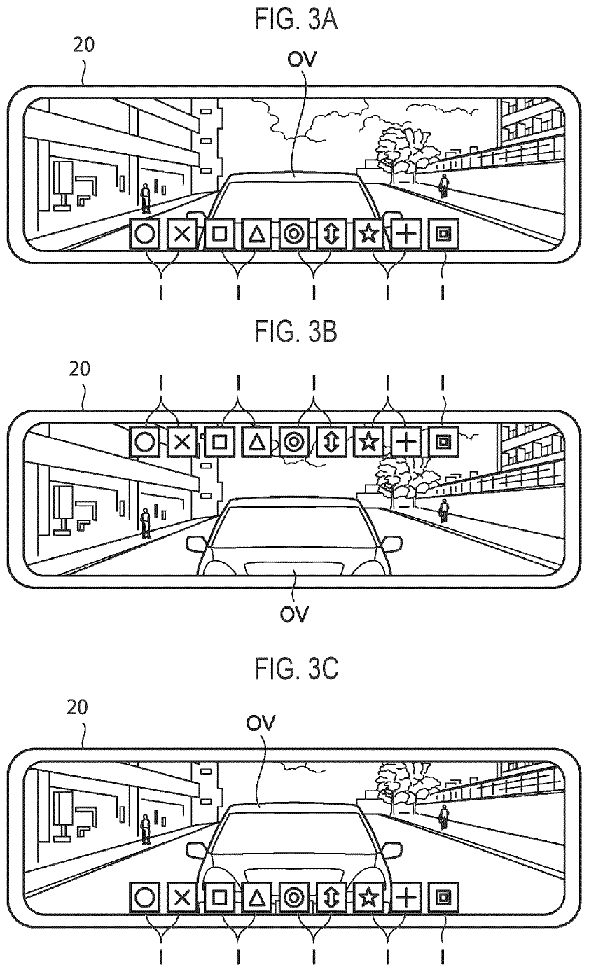

The electronic inner mirror 20 is a vehicle electronic device that provides a rear view. The electronic inner mirror 20 is attached, for example, to an upper center portion of a windshield in a vehicle cabin of the vehicle V. As shown in FIG. 3A, the electronic inner mirror 20 displays the rear image acquired by the image acquisition unit 11 and a plurality of icon displays I. The icon displays I constitute a selection unit configured to change a display mode of the rear image on the electronic inner mirror 20. The icon displays I are not particularly limited, and may be various shapes, symbols, characters, and a combination of at least any of these that perform various functions. For example, the icon displays I are displayed side by side in a left-right row at the lower portion of the electronic inner mirror 20 during a normal state.

In the present embodiment, when the distance detected by the distance detection unit 12 falls below a predetermined threshold value, the display control unit 13 controls the electronic inner mirror 20 as follows. That is, the display control unit 13 controls the display on the electronic inner mirror 20 such that a degree of overlap between the other vehicle OV in the peripheral image and the icon displays I that are displayed on the electronic inner mirror 20 is reduced.

The predetermined threshold value is set in advance and stored in the ECU 10, for example. The predetermined threshold value is determined for each number of steps of the tilt adjustment function set in the rear camera 2. That is, predetermined threshold values L1 to Ln are set and stored corresponding to the respective tilt adjustment steps 1 to n. The overlap between the other vehicle OV and the icon displays I means, in other words, for example, that the icon displays I cover the other vehicle OV on the electronic inner mirror 20. The degree of overlap between the other vehicle OV and the icon displays I may correspond to, for example, a proportion of a portion of the other vehicle OV appearing on the electronic inner mirror 20 that is obscured by the icon displays I.

There is a case where the vehicle-to-vehicle distance detected by the distance detection unit 12 falls below the predetermined threshold value and a time-to-collision TTC between the vehicle V and the other vehicle OV is within a predetermined time. In such a case, the display control unit 13 determines that the urgency is high and changes the angle of view of the rear camera 2. Specifically, when the vehicle-to-vehicle distance detected by the distance detection unit 12 falls below the predetermined threshold value and the time-to-collision TTC is within the predetermined time, the display control unit 13 widens the angle of view of the rear camera 2 by a predetermined angle.

The predetermined time is set in advance and stored in the ECU 10, for example. The predetermined time is, for example, 2 seconds. The time-to-collision TTC is a time until the other vehicle OV collides with the vehicle V, and can be calculated according to Equation (3). x is a position of the vehicle V at time t, and a terminal position (position in contact with the other vehicle OV) is set to 0. Since the scene is a scene in which the terminal position is approached, x is equal to or less than 0. a is an acceleration, and since the scene is a deceleration scene, a is less than 0. v0 is a speed of the vehicle V at the terminal position (x=0). The predetermined angle is set in advance and stored in the ECU 10, for example.

$$Time - to - collision TTC = - x / {( 2 ax + v {0}^{2} )}^{0.5} \qquad ( 3 )$$

There is a case where the vehicle-to-vehicle distance detected by the distance detection unit 12 falls below the predetermined threshold value and the time-to-collision TTC between the vehicle V and the other vehicle OV is greater than the predetermined time. In such a case, the display control unit 13 adjusts positions of the icon displays I on the electronic inner mirror 20. Specifically, when the vehicle-to-vehicle distance detected by the distance detection unit 12 falls below the predetermined threshold value and the time-to-collision TTC is greater than the predetermined time, the display control unit 13 changes the positions of the icon displays I arranged side by side in a left-right row at the lower portion of the electronic inner mirror 20 to positions arranged side by side in a left-right row at the upper portion of the electronic inner mirror 20.

The display control unit 13 may not execute each of the above-described controls when, in the electronic inner mirror 20, the other vehicle OV included in the rear image and the icon displays I do not overlap with each other. Whether the other vehicle OV and the icon display I overlap with each other may be determined by the display control unit 13 using a known technique based on an image processing result of the rear image and position information of the icon displays I on the electronic inner mirror 20.

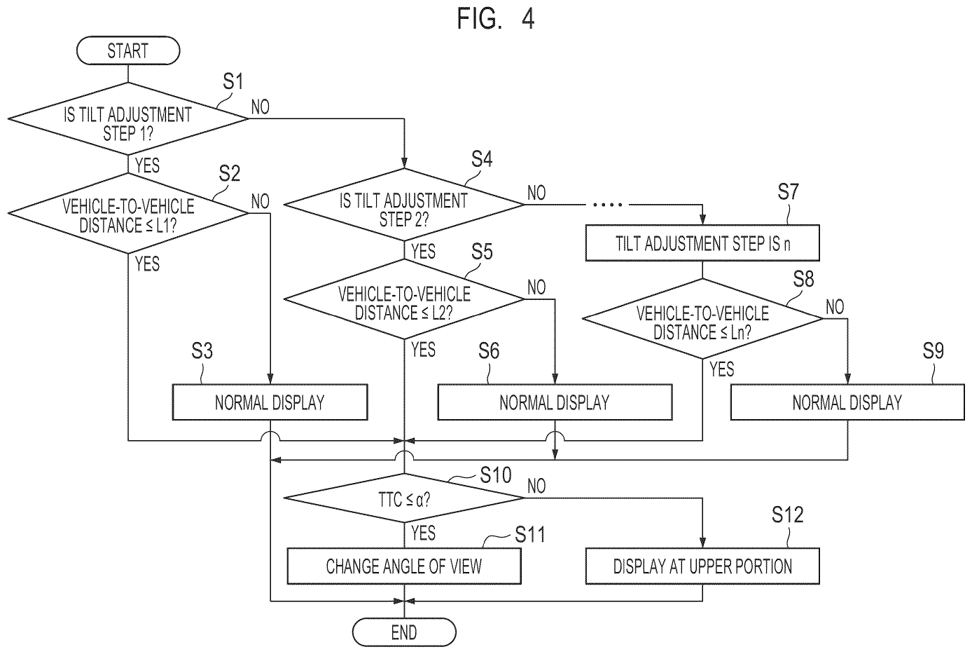

Next, a processing example of the vehicle image display device 1 will be described with reference to the flowchart of FIG. 4.

As shown in FIG. 3A, during the travel of the vehicle V, the rear image captured by the rear camera 2 is displayed on the electronic inner mirror 20, and the icon displays I are also displayed. In this state, in the vehicle image display device 1, when the other vehicle OV included in the rear image overlaps with the icon displays I, the display control unit 13 repeatedly executes the following processing.

That is, first, when the current number of tilt adjustment steps for the tilt adjustment function of the rear camera 2 is 1, it is determined whether the vehicle-to-vehicle distance is equal to or less than a predetermined threshold value L1 (S1, S2). As a result of the determination in S2, when the vehicle-to-vehicle distance is greater than the predetermined threshold value L1, the display on the electronic inner mirror 20 is maintained as the normal display without change, and the processing of the present cycle ends (S3). On the other hand, as a result of the determination in S2, when the vehicle-to-vehicle distance is equal to or less than the predetermined threshold value L1, the process proceeds to the subsequent S10. Each of these processes is performed in order for the number n of tilt adjustment steps while changing the predetermined threshold value (S4 to S9). The normal display is a display including the rear image captured by the rear camera 2 at the tilt angle corresponding to the current number of tilt adjustment steps and the icon displays I displayed to be arranged side by side in a left-right row at the lower portion of the electronic inner mirror 20 (for example, see FIG. 3A).

As S10, it is determined whether the time-to-collision TTC is equal to or less than a predetermined time α. As a result of the determination in S10, when the time-to-collision TTC is equal to or less than the predetermined time α, the angle of view of the rear camera 2 is changed (S11). In S11, the angle of view of the rear camera 2 is widened by a predetermined angle (see FIG. 3C). As a result of the determination in S10, when the time-to-collision TTC is greater than the predetermined time α, the positions of the icon displays I on the electronic inner mirror 20 are adjusted, so that the icon displays I are displayed at the upper portion (S12). In S12, the positions of the icon displays I on the electronic inner mirror 20 are changed to positions arranged side by side in a left-right row at the upper portion of the electronic inner mirror 20 (see FIG. 3B). After S11 and S12, the processing of the present cycle ends.

For example, when the travel of the vehicle V ends and the other vehicle OV included in the rear image and the icon displays I no longer overlap with each other, the repeated processing from S1 to S12 described above ends.

In the vehicle image display device 1, there is a case where the vehicle-to-vehicle distance between the other vehicle OV included in the peripheral image and the vehicle V falls below the predetermined threshold value. In the vehicle image display device 1, in such a case, the display on the electronic inner mirror 20 is controlled such that the degree of overlap between the other vehicle OV and the icon displays I displayed on the electronic inner mirror 20 is reduced. As a result, for example, in the electronic inner mirror 20, it is possible to suppress a situation in which the icon displays I obstruct the view of the other vehicle OV, so that it is possible to suppress the deterioration of the visibility of the user.

In the vehicle image display device 1, when the vehicle-to-vehicle distance detected by the distance detection unit 12 falls below the predetermined threshold value and the time-to-collision TTC is within the predetermined time α, the display control unit 13 changes the angle of view of the rear camera 2. As a result, when the time-to-collision TTC is within the predetermined time α, it is determined that the urgency is high, and the deterioration of the visibility of the user can be suppressed by changing the angle of view of the rear camera 2.

In the vehicle image display device 1, there is a case where the vehicle-to-vehicle distance detected by the distance detection unit 12 falls below the predetermined threshold value and the time-to-collision TTC is greater than the predetermined time α. In such a case, the display control unit 13 adjusts the positions of the icon displays I on the electronic inner mirror 20. In this way, by adjusting the positions of the icon displays I, it is possible to suppress the deterioration of the visibility of the user.

In the vehicle image display device 1, there is a case where the vehicle-to-vehicle distance detected by the distance detection unit 12 falls below the predetermined threshold value and the time-to-collision TTC is within the predetermined time α. In such a case, the display control unit 13 widens the angle of view of the rear camera 2. In addition, in the vehicle image display device 1, there is a case where the vehicle-to-vehicle distance detected by the distance detection unit 12 falls below the predetermined threshold value and the time-to-collision TTC is greater than the predetermined time α. In such a case, the display control unit 13 changes the positions of the icon displays I arranged side by side in a left-right row at the lower portion of the electronic inner mirror 20 to positions of the icon displays I arranged side by side in a left-right row at the upper portion of the electronic inner mirror 20. In this case, when the time-to-collision TTC is within the predetermined time α, it is determined that the urgency is high, and the deterioration of the visibility of the user can be suppressed by widening the angle of view of the rear camera 2. When the time-to-collision TTC is greater than the predetermined time α, the deterioration of the visibility of the user can be suppressed by changing the positions of the icon displays I to be arranged side by side in a left-right row at the upper portion of the electronic inner mirror 20.

Although the embodiment has been described above, the aspect of the present disclosure is not limited to the embodiment described above. The aspect of the present disclosure can be implemented in various forms with various modifications and improvements based on the knowledge of those skilled in the art, in addition to the embodiment.

In the embodiment, the display control unit 13 may adjust the positions of the icon displays I based on a proportion of an area of the other vehicle OV appearing on the electronic inner mirror 20 to a total area of a display screen of the electronic inner mirror 20 (that is, a total area of a region of the electronic inner mirror 20 in which an image can be displayed).

In the embodiment, in S12, the icon displays I are displayed at the upper portion as the adjustment of the positions of the icon displays I, but the present disclosure is not limited thereto, and for example, the positions of the icon displays I may be adjusted as follows.

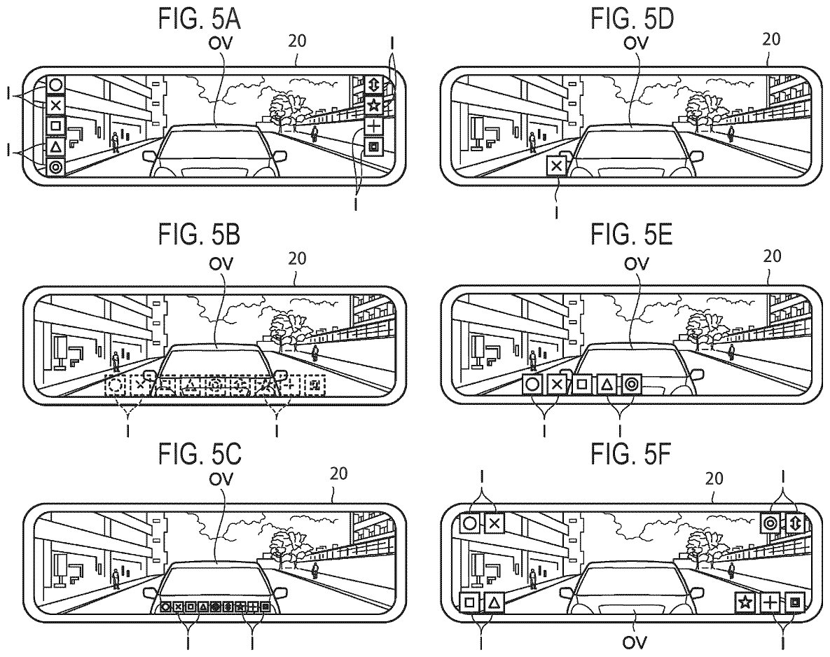

That is, there is a case where the vehicle-to-vehicle distance detected by the distance detection unit 12 falls below the predetermined threshold value and the time-to-collision TTC is greater than the predetermined time α. In such a case, the display control unit 13 may change the positions of the icon displays I on the electronic inner mirror 20 to positions arranged vertically in the left region and the right region, respectively (that is, display at the left and right sides) (see FIG. 5A). In this way, by causing the icon displays I to be displayed at the left and right sides, it is possible to suppress the deterioration of the visibility of the user.

In addition, there is a case where the vehicle-to-vehicle distance detected by the distance detection unit 12 falls below the predetermined threshold value and the time-to-collision TTC is greater than the predetermined time α. In such a case, the display control unit 13 may cause the icon displays I to be displayed on the electronic inner mirror 20 in a transparent manner (in other words, cause the icon displays I to be displayed so that the rear image appears through the icon displays I) (see FIG. 5B). In this way, by causing the icon displays I to be displayed in a transparent manner, it is possible to suppress the deterioration of the visibility of the user.

In addition, there is a case where the vehicle-to-vehicle distance detected by the distance detection unit 12 falls below the predetermined threshold value and the time-to-collision TTC is greater than the predetermined time α. In such a case, the display control unit 13 may cause, among the icon displays I on the electronic inner mirror 20, some of the icon displays I to be displayed. In this case, for example, among the icon displays I on the electronic inner mirror 20, the icon display I related to the selection item may be displayed on the electronic inner mirror 20 (see FIG. 5D). In addition, in this case, for example, among the icon displays I on the electronic inner mirror 20, the one or more of the icon displays I related to the angle of view adjustment item of the rear camera 2 may be displayed on the electronic inner mirror 20 (see FIG. 5E). In this way, by causing some of the icon displays I to be displayed, it is possible to suppress the deterioration of the visibility of the user.

In addition, there is a case where the vehicle-to-vehicle distance detected by the distance detection unit 12 falls below the predetermined threshold value and the time-to-collision TTC is greater than the predetermined time α. In such a case, the display control unit 13 may change the positions of the icon displays I on the electronic inner mirror 20 to positions at the upper portion and the lower portion of the left region and the right region, respectively (that is, display at four corners) (see FIG. 5F). In this way, by causing the icon displays I to be displayed at the four corners, it is possible to suppress the deterioration of the visibility of the user.

In addition, there is a case where the vehicle-to-vehicle distance detected by the distance detection unit 12 falls below the predetermined threshold value and the time-to-collision TTC is greater than the predetermined time α. In such a case, the display control unit 13 may cause the icon displays I on the electronic inner mirror 20 to be displayed on a display different from the electronic inner mirror 20. In this way, by causing the icon displays I to be displayed on a different display, it is possible to suppress the deterioration of the visibility of the user.

In the embodiment, the icon displays I are displayed as the selection unit, but the selection unit is not particularly limited, and may be configured to change the display mode of the rear image. In the embodiment, the rear camera 2 is provided as the imaging unit, but the imaging unit is not particularly limited, and may be another camera or the like that captures an image of the periphery of the vehicle V to acquire the peripheral image.

In the embodiment, the ECU 10 may determine, for example, whether the driver of the vehicle V is susceptible to car sickness based on monitoring results of a driver monitoring unit. When it is determined that the driver of the vehicle V is susceptible to car sickness, the display control unit 13 adjusts the display as follows such that the driver does not feel unwell due to the change in the angle of view of the rear camera 2. That is, the display control unit 13 may adjust the positions of the icon displays I on the electronic inner mirror 20 (for example, display at the upper portion) instead of changing the angle of view of the rear camera 2.

In the embodiment, the vehicle-to-vehicle distance with the other vehicle OV may be acquired by using the radar sensor, or may be acquired by using the stereo camera as the rear camera 2. The configurations in the embodiment and the modification are not limited to the above-described materials and shapes, and various materials and shapes can be applied. In addition, the respective configurations in the embodiment described above and the modification described above can be optionally applied to the configurations in other embodiments or modifications.

What is claimed is:

1. A vehicle image display device mounted in a vehicle, the vehicle image display device comprising:
an image acquisition unit configured to acquire a peripheral image captured by an imaging unit configured to capture an image of a periphery of the vehicle;
a display unit configured to display the peripheral image acquired by the image acquisition unit and a selection unit configured to change a display mode of the peripheral image;
a distance detection unit configured to detect a vehicle-to-vehicle distance between another vehicle included in the peripheral image and the vehicle; and
a display control unit configured to control a display on the display unit such that, when the vehicle-to-vehicle distance detected by the distance detection unit falls below a predetermined threshold value, a degree of overlap between the other vehicle in the peripheral image and the selection unit that are displayed on the display unit is reduced.

2. The vehicle image display device according to claim 1, wherein the display control unit is configured to change, when the vehicle-to-vehicle distance detected by the distance detection unit falls below the predetermined threshold value and a time-to-collision between the vehicle and the other vehicle is within a predetermined time, an angle of view of the imaging unit.

3. The vehicle image display device according to claim 1, wherein:
the selection unit includes a plurality of icon displays; and
the display control unit is configured to adjust, when the vehicle-to-vehicle distance detected by the distance detection unit falls below the predetermined threshold value and a time-to-collision between the vehicle and the other vehicle is greater than a predetermined time, positions of the icon displays on the display unit.

4. The vehicle image display device according to claim 1, wherein:
the selection unit includes a plurality of icon displays; and
the display control unit is configured to cause, when the vehicle-to-vehicle distance detected by the distance detection unit falls below the predetermined threshold value and a time-to-collision between the vehicle and the other vehicle is greater than a predetermined time, either or both of transparent display of the icon displays and display of some of the icon displays to be performed on the display unit.

5. The vehicle image display device according to claim 1, wherein:
the selection unit includes a plurality of icon displays; and
the display control unit is configured to
widen, when the vehicle-to-vehicle distance detected by the distance detection unit falls below the predetermined threshold value and a time-to-collision between the vehicle and the other vehicle is within a predetermined time, an angle of view of the imaging unit, and
change, when the vehicle-to-vehicle distance detected by the distance detection unit falls below the predetermined threshold value and the time-to-collision between the vehicle and the other vehicle is greater than the predetermined time, positions of the icon displays arranged side by side in a left-right row at a lower portion of the display unit to positions of the icon displays arranged side by side in a left-right row at an upper portion of the display unit.
